(19) United States
(12) Patent Application Publication
(10) Pub. No.: US 2011/0126089 A1
(43) Pub. Date: May 26, 2011

(54) Electronic device and method of browsing web albums thereon

(75) Inventors: Teng-Yu Tsai, Tu-Cheng (TW); Yuan-Fu Huang, Tu-Cheng (TW); Chien-Huang Chang, Tu-Cheng (TW); Chun-Jung Ke, Tu-Cheng (TW); Feng-Chi Hsiao, Tu-Cheng (TW); Ting-Chieh Lin, Tu-Cheng (TW)

(73) Assignee: HON HAI PRECISION INDUSTRY CO., LTD., Tu-Cheng (TW)

(21) Appl. No.: 12/657,572

(22) Filed: Jan. 21, 2010

(30) Foreign Application Priority Data
Nov. 23, 2009 (CN) 200910310223.7

(51) Int. Cl. G06F 17/00; G06F 3/048

(52) U.S. Cl. 715/234; 715/764

(57) ABSTRACT

An electronic device browses Web albums. The electronic device includes a connecting module, a download module, a parser module, and a display. The connecting module connects to a Website. The download module downloads a first Hyper Text Markup Language (HTML) Web file of the Website associated with Web albums. The parser module parses the first HTML Web file to get Web album information. The display displays Web albums according to the Web album information.

### BACKGROUND

1. Technical Field

The present disclosure relates to electronic devices and methods, and particularly to an electronic device and a method of browsing Web albums on the electronic device.

2. Description of Related Art

Presently, some embedded electronic devices (such as a digital photo frame) can connect to a network. The electronic device also connects to a Web site via the network. Some Web albums are stored in the Web site. Generally, a browser (such as Internet Explorer™) is used to browse the Web albums at the Web site. But the browser has many functions and is not convenient to install the browser in the embedded electronic device.

### BRIEF DESCRIPTION OF THE DRAWINGS

FIG. 1 a construction view of an electronic device in accordance with one embodiment.

FIG. 2 is a flowchart of a method of an electronic device login a Web site in accordance with one embodiment.

FIG. 3 is a flowchart of a method of an electronic device browsing Web albums.

FIG. 4 is a flowchart of a method of an electronic device browsing pictures.

FIG. 5 is a flowchart of a method of an electronic device parser a Web file.

FIG. 6 is a schematic view of an electronic device displaying Web albums.

FIG. 7 is a schematic view of an electronic device displaying pictures.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

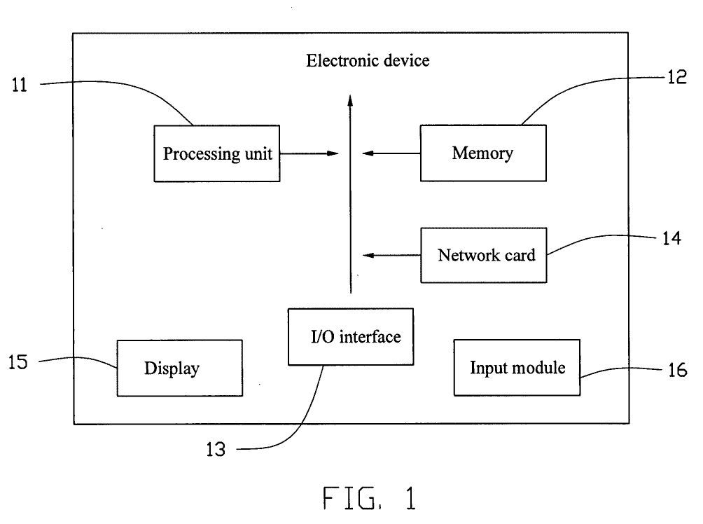

Referring to FIG. 1, an electronic device includes a processing unit 11, a memory 12, an Input/Output (I/O) interface 13, a network card 14, a display 15 and an input module 16. The display displays a user interface. The input module may be a remote controller. The electronic device may be a digital photo frame, a media player, or a personal computer.

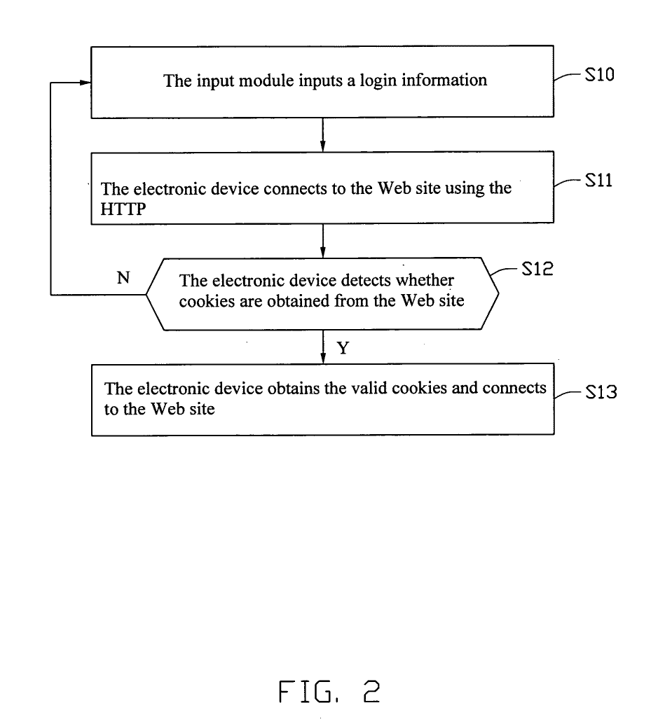

Referring to FIG. 2, one embodiment of a method of accessing a Web site from an electronic device includes the following blocks.

In block S10, the input module inputs a login information. The login information includes a user name and a password.

In block S11, the electronic device connects to the Web site using the Hyper Text Transfer Protocol (HTTP).

In block S12, the electronic device detects whether cookies are obtained from the Web site. If no, skip to S10; If yes, go to S13.

In block S13, the electronic device obtains the valid cookies and connects to the Web site.

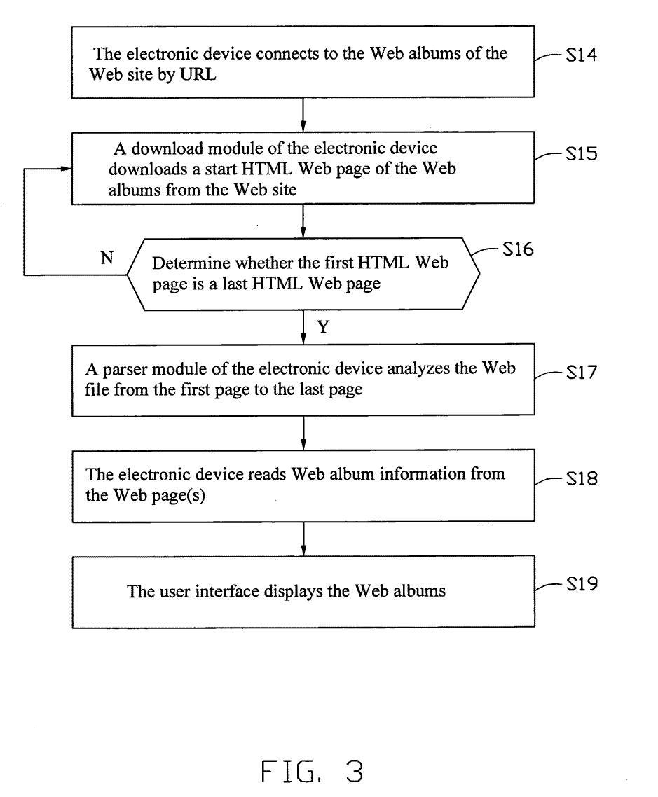

Referring to FIG. 3, one embodiment of a method of browsing Web albums by an electronic device includes the following blocks.

In block S14, the electronic device connects to the Web albums of the Web site by a Uniform Resource Locator (URL). Each Web album includes a plurality of pictures.

In block S15, a download module of the electronic device downloads a start Hyper Text Markup Language (HTML) Web page of the Web albums from the Web site. The HTML Web file of the Web albums may have many pages.

In block S16, determine whether the first HTML Web page is a last HTML Web page. If no, skip S15; If yes, go on S17.

In block S17, a parser module of the electronic device analyzes the Web file from the first page to the last page.

In block S18, the electronic device reads Web album information from the Web page(s).

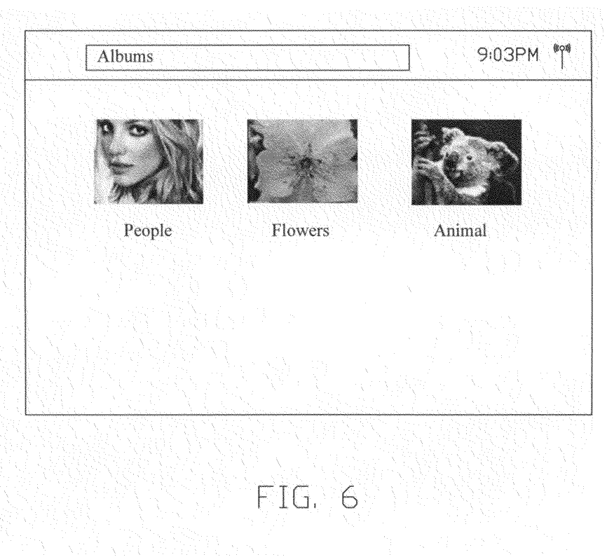

In block S19, the user interface displays the Web albums as shown in FIG. 6. Each web album is a folder having many web pictures. The display displays the Web albums page by page.

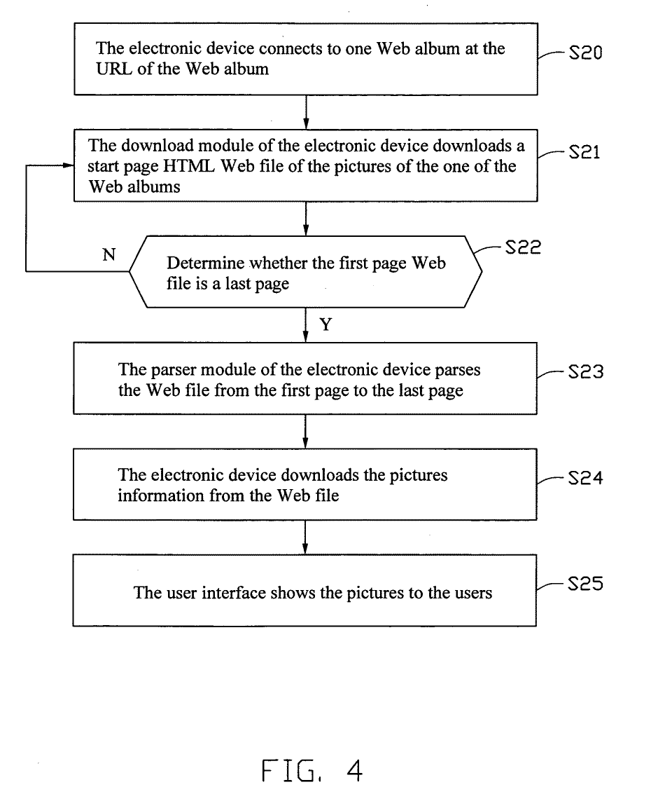

Referring to FIG. 4, one embodiment of a method of browsing pictures in the Web albums from an electronic device includes following blocks.

In block S20, the electronic device connects to one Web album at the URL of the Web album.

In block S21, the download module of the electronic device downloads a start page HTML Web file of the pictures of the one of the Web albums.

In block S22, determine whether the first page Web file is a last page. If no, skip to S21; If yes, go to S23.

In block S23, the parser module of the electronic device parses the Web file from the first page to the last page.

In block S24, the electronic device downloads the pictures information from the Web file.

In block S25, the user interface shows the pictures to the users. The display displays the pictures of the one Web album page by page.

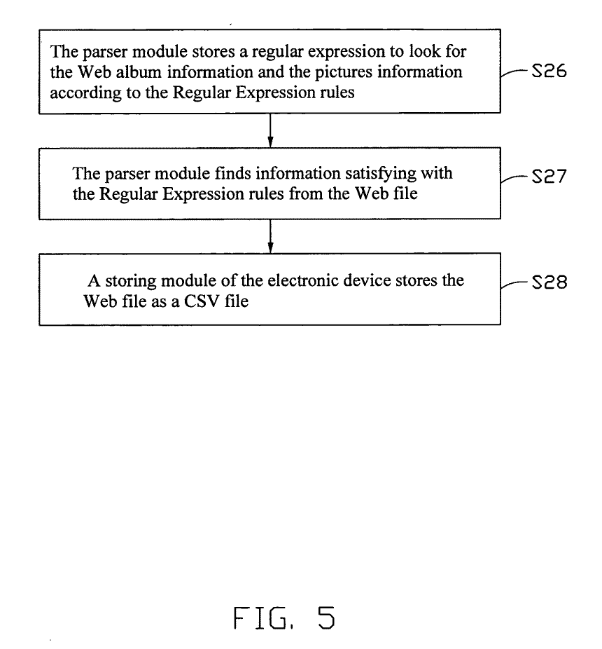

Referring to FIG. 5, one embodiment of a method of analyzing the Web file from an electronic device includes following blocks.

In block S26, the parser module stores a regular expression to look for the Web album information and the pictures information according to the Regular Expression rules. “www.TTT.com” is a Regular Expression rule to look for the address of the pictures information in the web file.

In block S27, the parser module finds information satisfying with the Regular Expression rules from the Web file. For example, name information, address information.

In block S28, a storing module of the electronic device stores the Web file as a Comma Separated Value (CSV) file. A separating module of the electronic device separates the name from the address by comma in the CSV file.

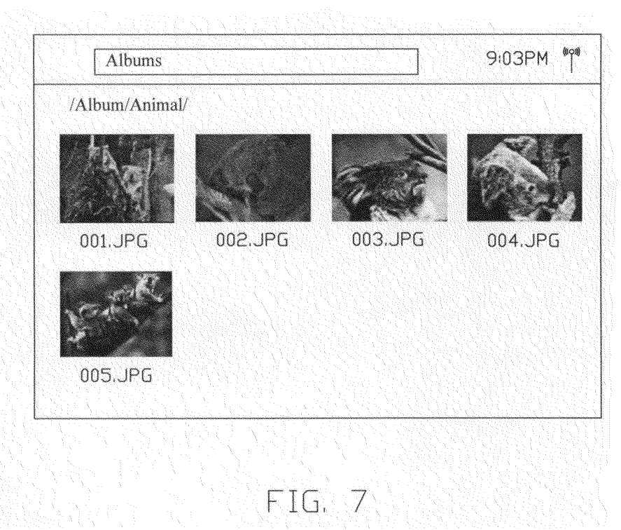

FIG. 6 is a schematic view of the Web albums on the electronic device. There are animal album, flowers album, and people album. FIG. 7 is a schematic view of the pictures display on the electronic device. The pictures come from the animal album.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic device capable of browsing Web albums, the electronic device comprising:
a connecting module capable of connecting to a Web site;
a download module capable of downloading a first Hyper Text Markup Language (HTML) Web file of the Web site associated with Web albums;
a parser module capable of analyzing the first HTML Web file to get Web album information; and
a display capable of displaying Web albums according to the Web album information.

2. The electronic device of claim 1, further comprising:
a selecting module capable of selecting one Web album from the Web albums;
the download module capable of downloading a second HTML Web file of the one Web album;
the parser module capable of analyzing the second HTML Web file to pictures in the one Web album; and
the display is capable of displaying the pictures.

3. The electronic device of claim 2, wherein the download module is capable of downloading the second HTML Web file from a first page to a last page of the second HTML Web file.

4. The electronic device of claim 1, wherein the parser module is capable of analyzing the first HTML Web file to the Web albums through a predetermined rule to find the Web album information.

5. The electronic device of claim 1, wherein the download module is capable of downloading the first HTML Web file from a first page to a last page of the first HTML Web file.

6. The electronic device of claim 1, further comprising a detecting module capable of detecting a login information from the electronic device.

7. The electronic device of claim 1, wherein the Web album information comprises a name and an address.

8. The electronic device of claim 7, further comprising:
a storing module capable of storing the first HTML Web file as a Comma Separated Value (CSV) file after the analyzing;
a separating module capable of separating the name from the address by comma in the CSV file; and
the display capable of reading the name and the address to display the Web albums.

9. The electronic device of claim 1, wherein the connecting module is capable of connecting to the Web site through obtaining valid cookies from the Web site.

10. The electronic device of claim 1, wherein the connecting module is capable of connecting to the Web site by a Hyper Text Transfer Protocol (HTTP).

11. A method of browsing Web albums on an electronic device, the method comprising:
connecting to a Web site by a connecting module;
downloading a first Hyper Text Markup Language (HTML) Web file of the Web site through a download module;
analyzing the first HTML Web file to Web albums of the Web site via a parser module; and
displaying the Web albums on a display of the electronic device.

12. The method of claim 11, further comprising:
selecting one Web album from the Web albums through a selecting module;
downloading a second HTML Web file of the one Web album through the download module;
analyzing the second HTML Web file having pictures in the one Web album via the parser module; and
displaying the pictures on the display of the electronic device.

13. The method of claim 12, wherein the download module downloads the second HTML Web file from a first page to a last page of the second HTML Web file.

14. The method of claim 11, wherein the parser module parses the first HTML Web file to the Web albums through a regular expression to find the Web album information.

15. The method of claim 11, wherein the download module downloads the first HTML Web file from a first page to a last page of the first HTML Web file.

16. The method of claim 11, further comprising detecting a user account to login the electronic device.

17. The method of claim 11, wherein the Web album information comprises a name and an address.

18. The method of claim 17, further comprising:
storing the first HTML Web file as a Comma Separated Value (CSV) file after analyzing;
separating the name from the address by comma in the CSV file; and
reading the name and the address to display the Web albums on the display.

19. The method of claim 11, wherein the electronic device connects to the Web site through getting valid cookies from the Web site.

20. The method of claim 11, wherein the electronic device connects to the Web site by a Hyper Text Transfer Protocol (HTTP).
